(19) United States
(12) Patent Application Publication
(10) Pub. No.: US 2009/0231551 A1
(43) Pub. Date: Sep. 17, 2009

(54) Digital imaging system

(75) Inventor: Martin Franik, Postredni Becva (CZ)

Correspondence Address: HEINZ GRETHER PC;G2 Technology Law, P.O. Box 40610, AUSTIN, TX, 78704, US

(73) Assignee: ROBE SHOW LIGHTING S.R.O.

(21) Appl. No.: 12/075,472

(22) Filed: Mar. 11, 2008

(51) Int. Cl. G03B 21/14

(52) U.S. Cl. 353/69; 353/70

(57) ABSTRACT

The present invention provides a projection system capable of making corrections to the shape of a projected light beam to take into account multiple irregularities in a projection surface. The invention also provides a projection system capable of adjusting the variation of intensity of a light beam projected on a projection surface that is not normal to the central axis of the projection beam.

### TECHNICAL FIELD OF THE INVENTION

The present invention generally relates to the projection of images and more specifically to digital imaging systems used for the correction of images when projected onto multi-planar surfaces.

### BACKGROUND OF THE INVENTION

Projection systems are commonly used in many different entertainment and commercial applications. Such products are commonly used in theatres, television studios, concerts, theme parks, night clubs and other venues. These systems may be used to project content from video sources such as DVD players or video cameras or may project a video stream that is computer generated. One application for such devices is as a digital light where a video projection system is used as a lighting instrument giving the user full control over the imagery, color, patterns and output of the luminaire. An example of such a system is the Icon M from Light & Sound Design.

In many cases the imagery used in these projectors is produced by a media server. A media server is usually a computer hardware and software based system which allows the user to select a video image from an external library, manipulate and distort that image, combine it with other images and output the completed imagery as a video stream. Examples of some of the many different manipulations available might include image rotation & scaling, overlaying multiple images and color change.

A common manipulation provided in prior art systems is the ability to apply keystone correction to a projected image. FIG. 1 illustrates a prior art system with a projector 1 and an object or screen 2 which provides a projection surface. The axis of projection 4 for projector 1 is perpendicular to the projection surface and the projected beam 3 is thus symmetrical on the projection surface 2 about the axis 4. Source image 10 (which may be generated as the output from a media server) is sent to the projector 1 which then outputs it as source image 10 on the projection surface of object 2. The relative proportions of source image 10 are unchanged by the projection process into the viewed image 7. In particular in this example left source image height 8 is equal to the right source image height 9 and left viewed image height 5 is equal to the right viewed image height 6. Projection has not distorted the image.

FIG. 2 shows the situation where projector has been moved and the axis of projection 4 for projector 1 is rotated from the first position such that it is no longer perpendicular to the projection surface of object 2. Although source image 10 is unchanged and the left source image height 8 is equal to the right source image height 9, because of the difference in path lengths between the right and left hand edges of the projected beam 3 this is no longer true for the viewed image and the left viewed image height 5 is greater than the right viewed image height 6. This leads to the trapezoidal distortion of the viewed image 7 shown in FIG. 2. This distortion is commonly known as keystone distortion due to the keystone shape of the viewed image.

To correct for this distortion in the viewed image it is known to apply a prior and compensatory distortion to source image 10 as illustrated in FIG. 3. Now source image 10 is pre-distorted such that the left source image height 8 is less than the right source image height 9. The amount of pre-distortion is chosen such that the viewed image 7 is fully corrected and the left viewed image height 5 is once again equal to the right viewed image height 6. Although such pre-distortion corrects the shape of the projected image it does not correct the intensity variations across the image due to differences in angle and distance. In the example shown in FIG. 3 the right side of the image 6, which is closer to the projector, will be higher in intensity than the left side 5.

The manipulation of the image to correct for keystone correction in this manner may be undertaken either in the media server generating the images or within the projector 1. Although the illustrations here cover keystone in a single, horizontal, axis it is known in the art to provide this correction on both the vertical and horizontal axes either simultaneously or separately to correct for all off axis projection situations. An example of a product utilizing such keystone correction is the DL-2 digital light from High End Systems in Austin, Tex.

The keystone correction systems previously described herein are designed to operate on a single plane projection surface. It would be advantageous to provide a system which was capable of providing geometry correction across multiple planes simultaneously, to be able to rotate the perceived viewed image plane, and to correct intensity variations across a single or multiple planes.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates an on axis projection system;

FIG. 2 illustrates an off axis projection system;

FIG. 3 illustrates an off axis projection system with keystone correction;

FIG. 4 illustrates a multi-planar projection system of one embodiment of the present invention;

FIG. 5 illustrates a multi-planar projection system of one embodiment of the present invention with keystone correction;

FIG. 6 illustrates a further aspect of a multi-planar projection system of one embodiment of the present invention with keystone correction;

FIG. 7 illustrates a further aspect of a multi-planar projection system of one embodiment of the present invention with keystone correction;

FIG. 8 illustrates an off axis projection system with brightness variation;

FIG. 9 illustrates screen brightness as a function of off axis projection.

FIG. 10 illustrates screen angle variations across a projected image

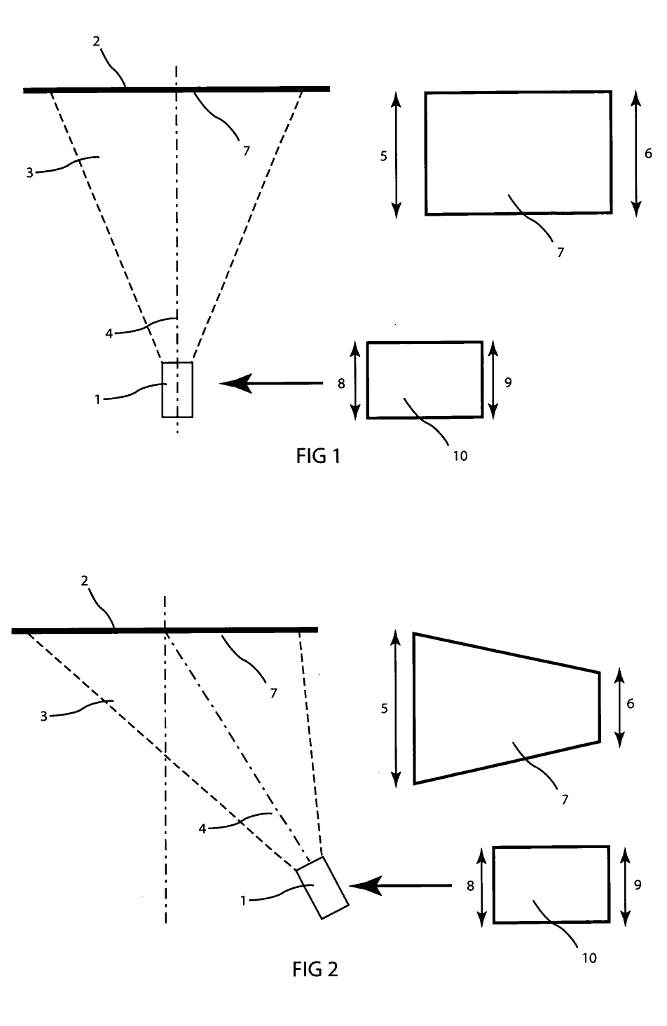

### DETAILED DESCRIPTION OF THE INVENTION

Preferred embodiments of the present invention are illustrated in the FIGUREs, like numerals being used to refer to like and corresponding parts of the various drawings.

The present invention generally relates to the projection of images and more specifically to digital imaging systems used for the correction of images when projected onto multi-planar surfaces.

In one embodiment the present invention utilizes a projection system with an associated means for providing pre-distortion of an image. Such means may be within the projection system or may be provided by an external processor or media server (not shown). Projection systems are known available to have on board signal processing capabilities. Likewise media servers are known to have signal processing capabilities to implement the signal processing described herein. Typically these systems contain the main components typically found in a personal computer. Some of these systems run on personal computer based operating systems or variations thereof and others run on proprietary hardware and operating system sets.

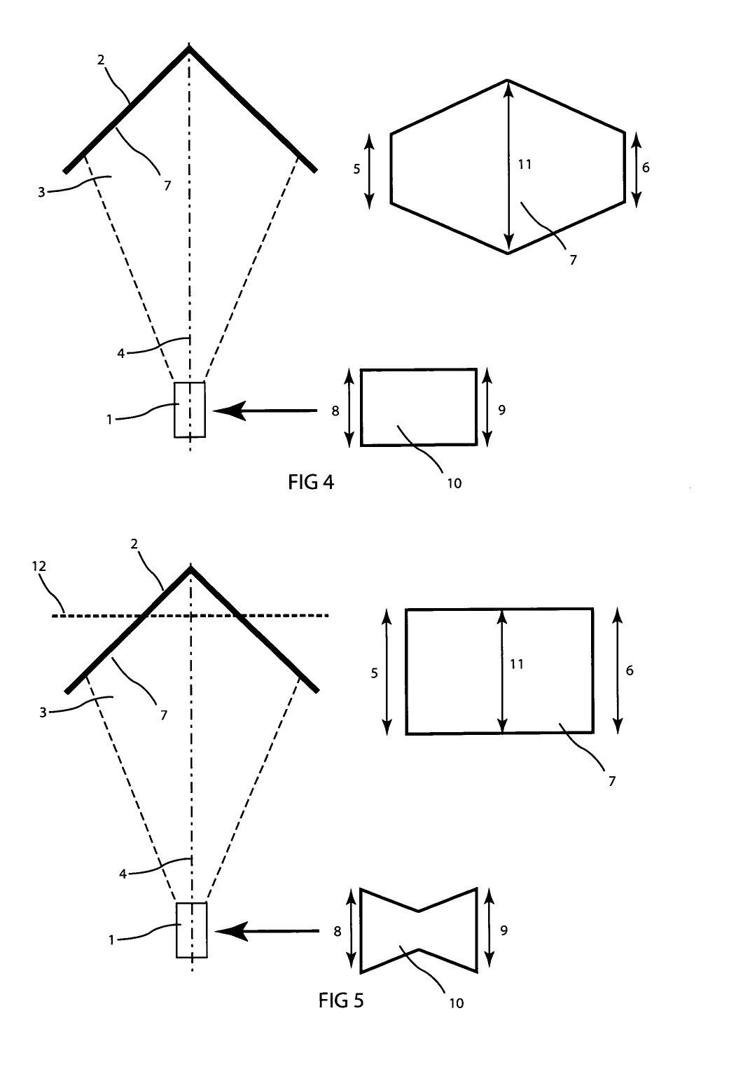

FIG. 4 illustrates a projector 1 and a multi planar object 2 with a projection surface. As illustrated the multi-planar object 2 is represented as an internal corner. The invention is not so limited and any arrangements and angles of the planes should be understood to be included in this description. The axis of projection 4 for projector 1 may be at any angle to the viewed planes of the projection surface such that the projected beam 3 impinges on the multiple planes at multiple different angles. The relative proportions of source image 10 are altered by the projection process into the viewed image 7. In particular in this example left source image height 8 is equal to the right source image height 9 however left viewed image height 5 may not be equal to the right viewed image height 6 and neither may be the same as the center viewed image height 11. The viewed image 7 has been keystone distorted onto two different planes producing a severely distorted output.

FIG. 5 illustrates an example of the pre-distortion that may be applied to the source image 10 such that the viewed image may be corrected. The pre-distortion applied to the source image 10 is in direction and amount such that it fully compensates for the distortion introduced by the projection onto multiple planes. In particular in this example the left and right ides of the source image have to be corrected by differing amounts to compensate for the two planes of the projection surface and the center of the source image 10 is reduced in size to counteract the expansion produced by the off-axis projection system. The resultant viewed image 7 shows no distortion and left, center and right (5, 11 and 6) source image heights are equal. In this example the effective resultant viewed image plane 12 will be normal to the axis of projection 4 or projector 1.

In a further embodiment of the invention the pre-distortion applied to the source image 10 may be varied such that the plane of the effective resultant viewed image may be rotated about one or more axes.

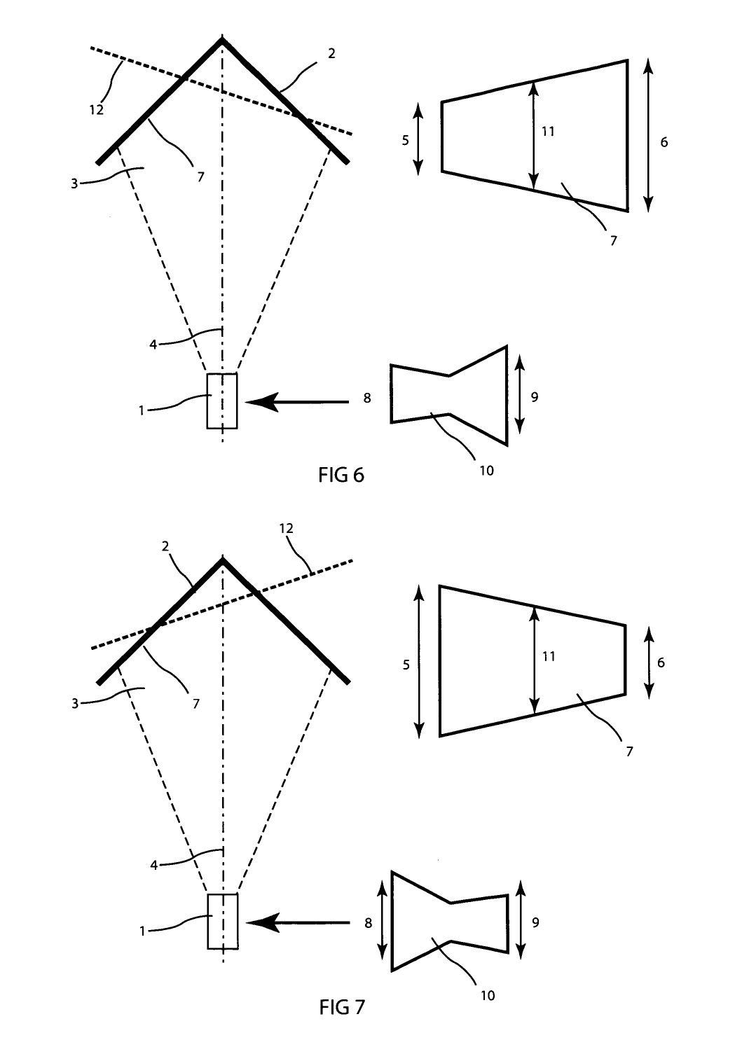

FIG. 6 illustrates a more complex pre-distortion being applied to the source image 10 such that the effective resultant viewed image 12 appears to the viewer to be undistorted but the effective projection plane is rotated clockwise from the position shown in FIG. 5.

FIG. 7 illustrates a yet further pre-distortion to the source image 10 such that the effective resultant viewed image 12 appears to the viewer to be undistorted but rotated counter-clockwise from the normal position shown in FIG. 5. Although only a limited number of positions for the effective resultant viewed image plane have been shown here the invention is not so limited and a continuum of effective resultant viewed image planes may be produced such that the plane of the effective resultant viewed image 12 may be positioned at any desired angle to the viewer. In particular there are specific sets of values value for pre-distortion that will position the effective resultant viewed image plane 12 coplanar with either of the two planes of projection surface 7 and give the viewers the impression that they are viewing a single plane projection surface.

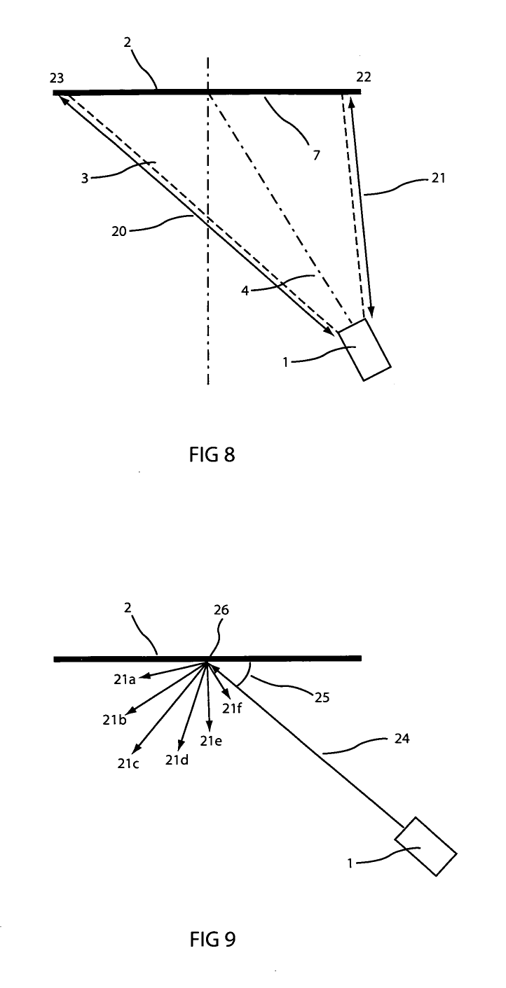

In addition to the geometric distortions and corrections described above there is a further form of distortion introduced by off axis projection, that of brightness or intensity distortion. FIG. 8 illustrates an off axis projection where projector 1 is projecting an image onto object 2. It can be seen that the projection distance for one side of the beam 21 is shorter than the projection distance for the other side of the beam 20. If the projector 1 is outputting a uniformly bright image then point 22 will be brighter than point 23. The brightness difference between points 22 and 23 may be calculated using the well known inverse square law for light propagation. A further embodiment of the invention corrects for this brightness difference by calculating and applying a brightness variation across the field of the projection to counteract the brightness difference caused by the path length differences introduced by an off axis projection.

In the example illustrated in FIG. 8 the projected beam 21 impinging the object at point 22 would be reduced in brightness by an amount necessary to match that of beam 20 impinging the object at point 23. Such correction may be input manually by an operator or may be automatically calculated by the system when the path lengths 20 and 21 are known.

A yet further brightness distortion may be introduced by the diffusivity of the screen. FIG. 9 illustrates an off axis projection where projector 1 is projecting an image onto object 2. A single light beam 24 is shown for clarity. Light beam 24 impinges on object 2 at point 26 and makes an angle 25 between the object and the beam. If the surface of object 2 were a perfectly diffusing Lambertian reflector then reflected beams 21a-21f would be of equal intensity in all directions. If the surface were a perfect specular mirror with no diffusion at all then all the reflected energy would fall in a single beam 21c where the relationship between incident beam 24 and reflected beam 21c follows the well known mirror relationship where the angle of incidence equals the angle of reflection. With real surfaces the diffusivity falls between these two extremes and they behave as imperfect diffusers with at least a portion of specular reflection. In such cases the brightness of the screen in any particular direction will vary depending on the incident angle of the projection 25 and the diffusivity of the surface. In FIG. 9 it can be seen that the brightest reflected beam is 21c where beam 21c makes the equal and opposite angle with the surface 2 as does the incident beam 24. As we move away from that angle the reflected beam brightness will be lower as shown in beams 21a, 21b, 21d, 21e and 21f.

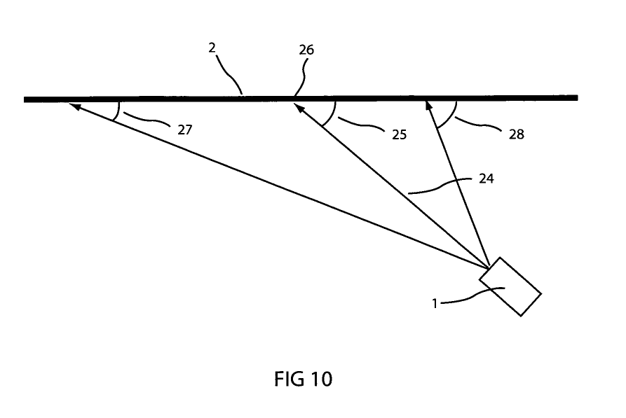

FIG. 10 illustrates the variation in angles formed with the screen by the projected image at different points. As different parts of the projected beam from projector 1 will impinge on the surface of object 2 at differing angles 25, 27 and 28 the reflected beam brightness will also vary across the image. A further embodiment of the invention corrects for this brightness difference by calculating and applying a brightness variation across the field of the projection to counteract the brightness difference caused by the variation ion brightness caused by angular differences on to a non-perfect diffusing surface. Such correction may be input manually by an operator or may be automatically calculated by the system when the projection distances and angles and projection surface diffusivity characteristics are known.

Although the illustrated examples shown discuss two planes and correction for projection the invention is not so limited. In further embodiments of the invention correction and rotation of the effective resultant viewed image plane may be achieved with a plurality of projection surface planes.

In a yet further embodiment the projection surface planes delineate a convex object

In a yet further embodiment the projection surface planes delineate a concave object

In a yet further embodiment the projection surface planes delineate a complex object with both convex and concave components.

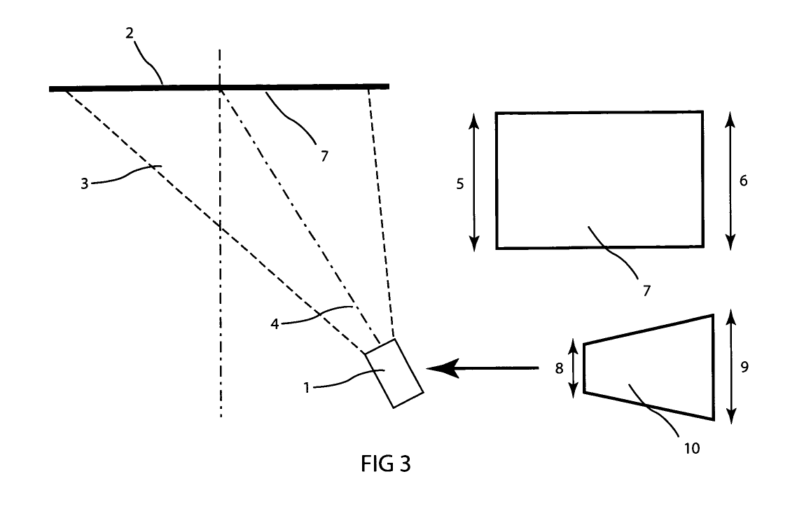

In yet further embodiment a current off-axis keystone correction as illustrated in FIG. 3 may be combined with a multiple plane projection surface correction to provide a complex combined pre-distortion.

In a yet further embodiment the plane of the effective resultant viewed image may be continuously rotated about a plurality of axes by continuously calculating and applying pre-distortions to the source image.

While the invention has been described with respect to a limited number of embodiments, those skilled in the art, having benefit of this invention, will appreciate that other embodiments may be devised which do not depart from the scope of the invention as disclosed herein. Accordingly, the scope of the invention should be limited only by the attached claims.

The invention has been described in detail, it should be understood that various changes, substitutions and alterations can be made hereto without departing from the spirit and scope of the invention as described by the appended claims.

What is claimed is:

1. A projector system comprising:
a projector for projecting a beam of light on a projection surface;
adjustments to the shape of the shape of the projected light beam to correct for multiple angular irregularities in the orientation of the projection surface.
